(19) United States
(12) Patent Application Publication
(10) Pub. No.: US 2022/0253509 A1
(43) Pub. Date: Aug. 11, 2022

(54) NETWORK-BASED CUSTOMIZED BROWSING NOTIFICATIONS

(71) Applicant: Wells Fargo Bank, N.A., San Francisco, CA (US)

(72) Inventors: Gregg C. Cascaes, Minneapolis, MN (US); Amy Jeanne Randt, St. Michael, MN (US); Peter D. Mauch, White Bear Lake, MN (US); John T. Walsh, Lakeville, MN (US); Nicholas J. Dooley, Maple Grove, MN (US); Christy Marie Lanz, Brooklyn Park, MN (US); Lisa Marie Thompson, Shoreview, MN (US); Jacob Dominic Surma, Big Lake, MN (US); Gregory W. Fletcher, Chanhassen, MN (US); Blake A. Christopherson, Elk River, MN (US)

(21) Appl. No.: 15/784,839

(22) Filed: Oct. 16, 2017

(51) Int. Cl. G06F 17/30

(52) U.S. Cl. CPC G06F 17/30905; G06F 17/30873; G06F 17/30598; G06F 17/30887

(57) ABSTRACT

A method may include accessing, using a web browsing application, content from a URL; categorizing, using a plugin to the web browsing application, the content from the URL; retrieving an impact score with respect to a data set of a user based on the categorization; determining that the impact score is above a threshold value; and presenting by the plugin, an impact user interface in response to the determining, the impact user interface comprising an indication of a potential impact to the data set of the user based on the impact score

### TECHNICAL FIELD

Embodiments described herein generally relate to user interfaces and, in particular but without limitation, to network-based customized browsing notifications.

### BACKGROUND

A user may access web content on the Internet using a web browser. The user may install a plugin to use in conjunction with the web browser. The plugin may read and modify the web content presented on a display device. For example, a plugin may present a definition of a highlighted word.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates use of an impact notification service, according to various examples.

FIG. 2 illustrates a schematic diagram of presenting a notification to a user, according to various examples.

FIGS. 3 and 4 illustrate impact user interfaces, according to various examples.

FIG. 5 illustrates a preferences interface, according to various examples

FIG. 6 is a flowchart illustrating a method to an impact user interface, according to various examples.

FIG. 7 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

The combination of both personal computers and the Internet has led to an overwhelming amount of information being available to users. One of the most common ways for users to view information is through a web browser on a mobile device or personal computer. In part because of the volume of information, a user may not be able to determine the impact a particular story may have with respect to their financial health. Some users may be able to recall the total amount of their invested assets, but may not know the holding in a particular asset class. Even if the user did not know this information, the user may not be able to determine the potential impact to their portfolio of the particular story because of the number of variables that go into determining such an impact. Thus, determining the impact present a technical problem that may not be solvable by the human mind alone. A similar problem may exist for financial advisers. For example, the financial advisor may read a story, but may not be able to determine the potential impact of the story with respect to the advisor's clients.

Systems are described herein that provide technical solutions to helping a user determine the potential impact of a story presented on a computing device with regard to a data set (e.g., a financial portfolio) associated with the user. In an example, a plugin is used in conjunction with a web browser to analyze content a webpage that the user is viewing. The plugin may categorize the content (e.g., perform a keyword analysis) and perform a semantic analysis of the content. A machine learning model may be applied to the categorized and analyzed content to determine a potential impact to the user's portfolio. Based on the impact score, a user interface may be presented to the user that includes the potential impact and suggested actions to take. The system may also use the actions taken by the user to improve future notifications presented to the user, or other users. Accordingly, the systems provide improvements to the technical fields of machine learning and user interfaces in order to solve the problems identified above. The systems may provide other improvements as one of ordinary skill in the art may recognize.

Furthermore, although discussed as a plugin to a web browser, the content analysis techniques described may be used in other scenarios. For example, general content presented on a mobile device (e.g., in an app) may be analyzed in a similar manner. Based on the results, a push notification may be transmitted or displayed to the user.

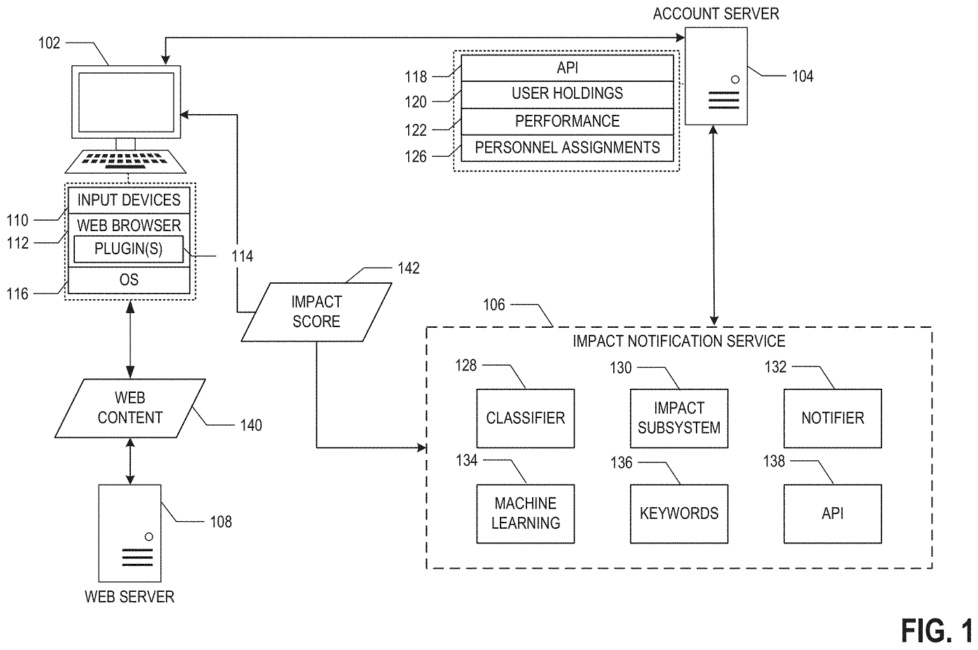

FIG. 1 illustrates use of an impact notification service 106, according to various examples. FIG. 1 includes user device 102, account server 104, impact notification service 106, and web server 108. User device 102 may include input devices 110, web browser 112, which may include plugin 114, and operating system 116. User device 102 may use web browser 112 to receive web content 140 from web server 108.

User device 102 may communicate with impact notification service 106 and account server 104 to receive impact score 142. Impact notification service 106 may include classifier 128, impact subsystem 130, notifier 132, machine learning component 134, keywords 136, and API 138. One or more networks may be used for the communication(s). A network may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network may include a single local area network (LAN) or wide-area network (WAN), or combinations of LAN's or WAN's, such as the Internet. The various devices coupled to the network may be coupled via one or more wired or wireless connections

Data used in impact notification service 106 (as well as other entities in FIG. 1) may be organized and stored in a variety of manners. For convenience, the organized collection of data is often described as being stored in a database. The specific storage layout and model used in a database may take a number of forms—indeed, s database may utilize multiple models. A database may be, but is not limited to, a relational database (e.g., SQL), non-relational database (NoSQL) a flat file database, object model, document details model, or a file system hierarchy. A database may store data on one or more storage devices (e.g., a hard disk, random access memory (RAM), etc.). The storage devices may be in standalone arrays, part of one or more servers, and may be located in one or more geographic areas. Data in a database may be accessed from a local device or may be requested from a remote device using a network.

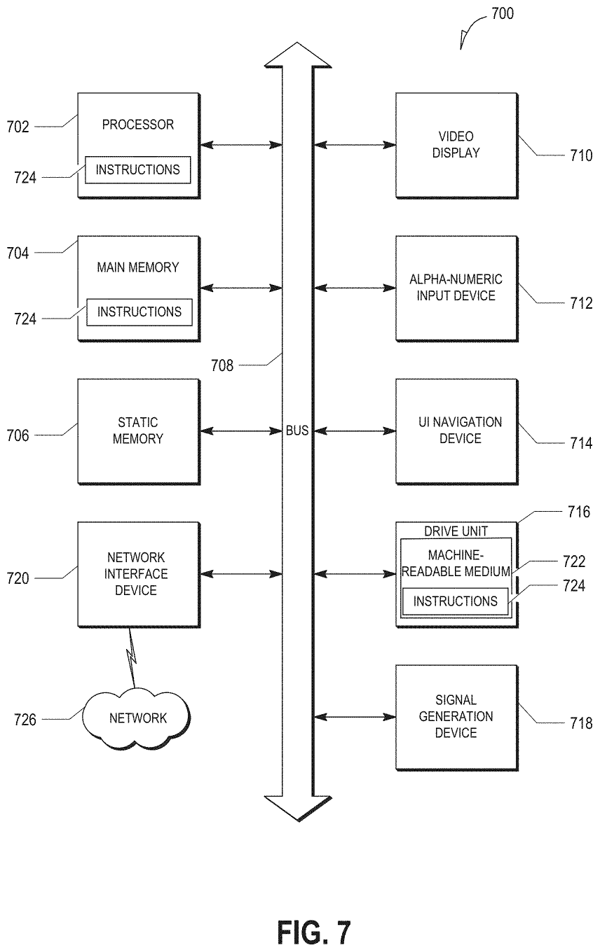

In an example, user device 102 may be a desktop computer, as depicted, or a mobile device, tablet device, etc. Input devices 110 may include a touch screen interface, a camera to detect gestures, a mouse, or keyboard, among others. User device 102 may include additional components such as illustrated in computer system 700 of FIG. 7.

Operating system 116 may be an event-driven operating system. For example, an application developer may write code using event calls on click, on drag, etc.) defined by the creator of impact notification service 106. Then, if the event occurs while the application is active (e.g., is in the foreground), the code that has been entered by the application developer associated with the event may be executed on a processor of user device 102. Accordingly, when a user clicks an object displayed on the device 102, the application may update the user interface, perform a process based on information included in the event, etc.

Web browser 112 may be an application that has been downloaded on to user device 102 or was preinstalled. Upon opening the application, the user may navigate to a web page that is served by web server 108. Serving a webpage may include transmitting (e.g., sometimes referred to as presenting) web content 140—such as a Hypertext Markup Language (HTML) document to user device 102. The web content 140 may be processed by a layout or rendering engine (e.g., Webkit, Blink Gecko) and display graphics and text element on a display device of user device 102. The presented graphics and text may be considered renderable content, according to various examples.

Web content 140 may also include data that is not presented to the user sometimes referred to as metadata. The metadata may be identified in the <head>portion of web content 140 according to various <meta>tags. Metadata may include a description of the web content, keywords, and authors, among other information.

In various examples, web browser 112 permits plugins to be executed in conjunction with web browser 112. Executing in conjunction may mean that all or part of input data and web content received by web browser 112 is shared with a plugin. In some examples, the plugin may run as a separate executable on user device 102. Plugins may be installed, disabled, or uninstalled by a user. A user may grant access to the plugin to read and process web content before the plugin in enabled. A plugin may execute natively on user device 102 or may offload some/all of the processing to external server(s).

A plugin may alter the renderable content (e.g., remove advertisements) as well as provide enhanced functionality to the presented content. For example, a user may highlight a word and the plugin may retrieve a definition for the word and present it within the web browser 112. As discussed further herein, a plugin may, in addition to presenting content, transmit notifications to a user outside of web browser 112. For example, a push notification may be transmitted to the user on a mobile device of the user. The push notification may also be presented within the web browser 112. As discussed further herein, a plugin may also analyze web content and present its impact to a particular user or group of users within web browser 112.

A user associated with user device 102 may have one or more accounts with financial institutions (e.g., banks, brokers, etc.). FIG. 1 illustrates a financial institution as exemplified by account server 104. Although a single account server is illustrated, the user may have multiple accounts with multiple financial institutions. Additionally, account server 104 may represent multiple computing devices that are located in a single location or geographically disperse.

In an example, account server 104 includes application programming interface (APT) 118, user holdings 120, performance data 122, and personnel assignments 126. An API provides a method for computing processes to exchange data. A web-based API, such as API 118, may permit communications between two or more computing devices. The API may define a set of HTTP calls according to Representational State Transfer (RESTful) practices.

A RESTful API may define various GET, PUT, POST, DELETE methods to create, replace, update, and delete data stored on a database of account server 104. For example, “GET /balance/userid” may be used to retrieve balance information for the identification indicated by “userid.” The same network endpoint may be reused to update the balance using “PUT /balance/userid.” API 118 may transmit responses to requests for data according to the JavaScript Object Notation (JSON) format. Similarly, data transmitted via API 118—from impact notification service 106, for example—may encoded in the JSON format and submitted in the content portion of the PUT request. API 118 may also permit filters/searches/modifications of a dataset—for example “GET /balance/userid?month=July2017 to retrieve the balance of a user for a particular month.

Because of the sensitive nature of data stored within account server 104, various security measures may be used to protect data at rest and while in transmit. For example, API 118 may use tokens or API keys to ensure only authorized parties may retrieve or update data impact notification service 106. Additionally, data transmitted over the network may use a cryptographic protocol, such Secure Socket Layer (SSL) or Transport Layer Security (TLS). As a further security precaution, the transmitted data itself may be encrypted, separately from the SSL or TLS encryption. Public-key infrastructure (PKI) may be leveraged for SSL/TLS, as well as the separate data encryption.

User holdings 120 may store information on what type of assets a user has and the amount held in each asset class. Assets may include fixed income (e.g., bonds, CDs, etc.), equities (stocks, mutual funds, etc.), cash (e.g., checking accounts, money market accounts, etc.), real estate, commodities, and the like. User holdings 120 may also be grouped by industries (e.g., technology, medical, energy). The industries may be correlated with one or more keyword categories (e.g., keywords 136). As appropriate, user holdings 120 may indicate the number of shares in each particular asset. In sum, user holdings 120 may identify a user's exposure (or risk) to movements in each type of asset. For example, if 50% of a user's holdings are in technology stocks, a news story that affects the technology sector, as a whole, may indicate a high likelihood of impacting the user.

User holdings 120 may aggregate user holding data from multiple financial institutions. For example, a user may grant access (e.g., using tokens, or username/passwords) to institutions associated with the user. An API may be used to query each institution and retrieve holding information from each institution.

Performance data 122 may store data on movements (e.g., share price, exchange rate, percentage change in value, etc.) of different asset classes, industry groupings and the like. The performance data may also track performance of a user's holdings as a whole—a personal rate of return, for example. Performance data 122 may also store data on different periods of time (e.g., daily, monthly, quarterly, yearly). Also, performance data 122 may be used in conjunction with news events to determine possible correlations, as discussed further herein. User holdings 120 may be associated with (e.g., managed by) one or more contact points (e.g., financial advisor, customer service representatives, etc.) at a financial institution. The contact points and the role of the contact point with respect to user holdings 120 may be stored in personnel assignments 126.

For illustration purposes, impact notification service 106 is illustrated as set of separate components. However, the functionality of individual components may be performed by a single component. A component may represent computer program code that is executable by a processing unit (e.g., a core of a general-purpose computer processor, a graphical processing unit, an application specific integrated circuit, etc.) The program code may be stored on a storage device and loaded into a memory of the processing unit for execution. Portions of the program code may be executed in a parallel across multiple processing units. Execution of the code may be performed on a single device or distributed across multiple devices. In some example, the program code is executed on a cloud platform (e.g., MICROSOFT AZURE® and AMAZON EC2®) using shared computing infrastructure.

Furthermore, FIG. 1 illustrates impact notification service 106 as external to user device 102. However, functionality of impact notification service 106 may be performed in whole or in part on user device 102. For example, impact notification service 106 may be a plugin (e.g., plugin 114) working in conjunction with web browser 112.

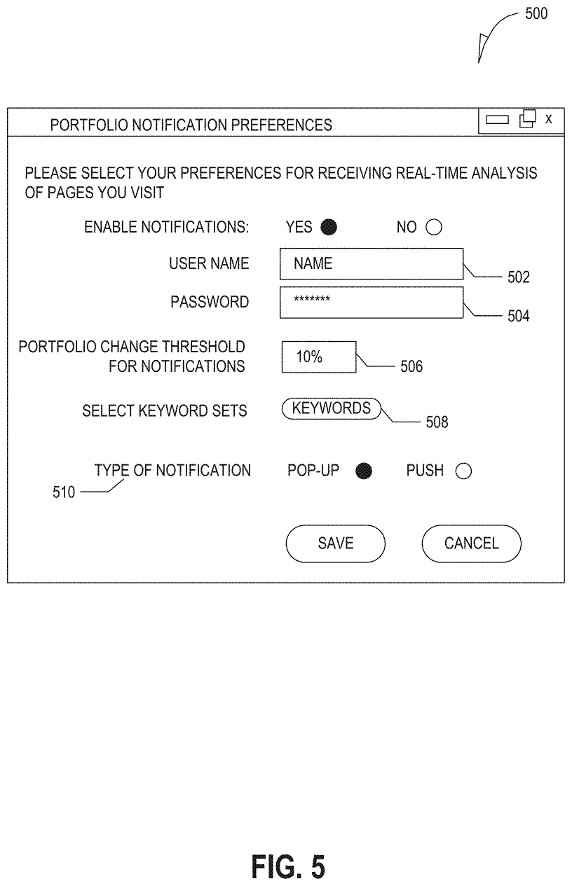

Impact notification service 106 may be used to classify web content, determine a potential impact to a user, and present a notification of the impact. To this end, a user may install a plugin that either executes or communicates with an external service that executes, the components of impact notification service 106. The user may grant access to the plugin to view web content that the user is browsing. Periodically, impact notification service 106 may remind the user of the access and offer the opportunity to opt-out of the service. As discussed further with respect to FIG. 5, the user may set preferences for the service and enter in a username/password for the impact notification service 106.

Classifier 128 may take, as input, web content and classify the content. The output classification may indicate several perceived features of the web content. The features may include a categorization of subject matter (e.g., technology, energy), a type (e.g., press release, news story, research paper) and a sentiment analysis (e.g., positive/negative). Multiple classifications may be given to a piece of web content. For example, a press release may be categorized as a technology sector story and an energy sector story.

To categorize the web content, classifier 128 may compare words of the web content to a set of keywords, such as keywords 136. Keywords 136 may store sets of keywords for different categories. For example, there may be a set of keywords for “technology” and another set for “energy.” The keywords may overlap between categories. Keywords 136 may be sourced from a variety of locations including industry lists, user generated lists, and the like. A given set of keywords may also include company names and stock ticker symbols associated with the category.

Classifier 128 may iterate through each keyword set and compare the respective set to the web content. In some examples, classifier 128 may use the metadata for the comparison. Alternatively, or in addition to the metadata, classifier 128 may compare the renderable content to the keyword set. A score may be calculated for each category in keywords 136 based on the frequency of the of keywords in the set appearing in the web content (e.g., one point for each keyword hit). In an example, the presence of a keyword in the metadata may be weighted higher than the same keyword appearing in the body. More sophisticated categorization and scoring techniques (e.g., support vector machines, neural networks, etc.) may be used without departing from the scope of this disclosure.

A respective score for a category may be compared to a threshold before the web content is considered to be the identified category. For example, a particular set of web content may be not be categorized as “energy” if the threshold is 50 hits and only 30 keyword hits were determined.

In addition to a category, classifier 128 may perform a sentiment analysis of the content. Any known sentiment analysis may be used. For example, one method may calculate the ratio of “positive” to “negative” words in the web content. The set of positive and negative words may be set before the analysis is run. More sophisticated techniques including, but not limited to, latent semantic analysis, support vector machines, and “bag of words” may also be employed by classifier 128. In some examples, the sentiment analysis may performed on a subset of the renderable content (e.g., the sentences include keywords from an identified category).

The output of classifier 128 may be expressed as a vector containing quantified values for the categories and sentiment. For example, <30, 50, 100, −0.05> representing a score for an energy category, a technology score, a real estate score, and a sentiment analysis score.

Machine learning component 134 may represent one or more machine learning models. For example, machine learning component 134 may include a movement model that, for a given set of inputs (e.g., the output of classifier 128 and a set of holdings), outputs the direction of movement of a set of assets (e.g., sectors of equities, specific stocks, indexes, etc.) over various time horizons (e.g., an hour, a day, a week). The movement model may be a neural network that include of a set of input nodes, one or more layers of hidden node, a set of output nodes. There may be an input node for each component of the vector output by classifier 128. There may be an output node for each modeled asset (company B, index B), etc.

The movement model may be trained over a period of time (e.g., a month) in a multistep process. The model may he updated over time using a similar process. First, impact notification service 106 may receive web content being viewed by users of impact notification service 106. The web content may be classified by classifier 128 as indicated above. Additionally, based on the publication data (e.g., using textual analysis of the content) machine learning component 134 may retrieve daily performance data of assets from account server 104 (e.g., performance data 122) using API 118 from the date of publication.

Then, machine learning component 134 may generation training data from the vector of the output from classifier 128 and the performance data. In other words, the model is given a set of inputs and an expected output (the observed changes in asset value over a time horizon). The weight of the nodes in each hidden layer may be updated each time a new piece of training data is fed into the model—also known as back propagation. In various examples, there may be a model for each user where the output nodes are limited to assets held by the user. Furthermore, similar models may be developed for different time periods. For example, a model may be trained using weekly or monthly data. Once the model has been trained, it may be used to calculate an impact score for new web content and present notifications to a user.

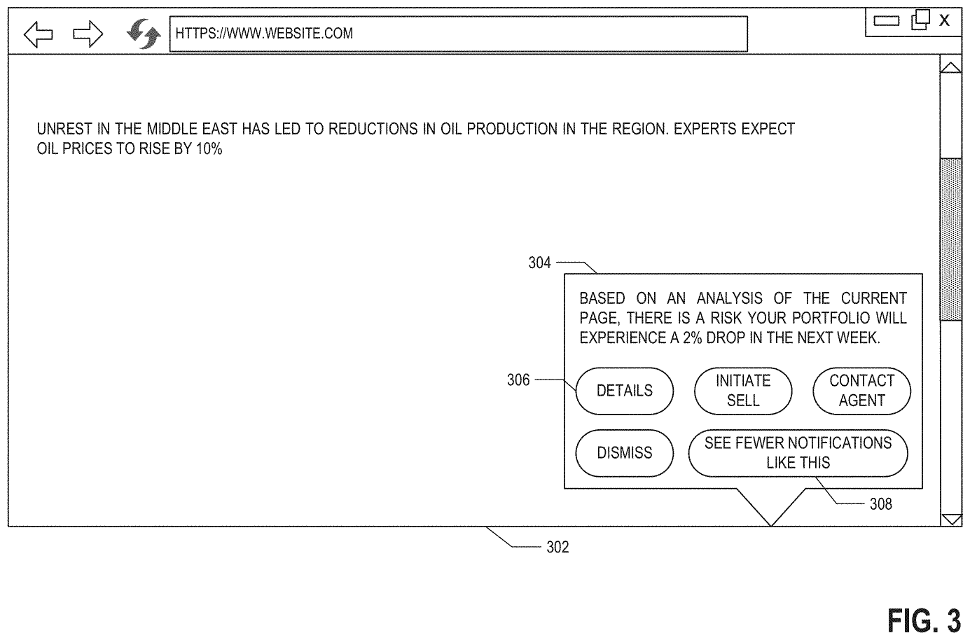

Machine learning component 134 may also include a machine learning model for when to notify a user (referred to a notification model). The notification model may be trained using a supervised training methodology. For example, initially impact notification service 106 may present a notification to a user using a lookup table or other static rules (e.g., if there is a greater than 10% chance of a 25% move in an asset class, notify). Options may be presented with the notification to a user—as discussed further with respect to FIG. 3.

Each of the options may have a corresponding numerical value of a positive or negative indication of whether the notification was useful to the user. For example, one option may be “contact your advisor” and have a value of 1 and an option of “dismiss this notification” may have a value of −0.2. Accordingly, over a training period, the notification model may determine the expected value of a notification to a user given an impact score. The notification model may also use other inputs such as demographic information of a user, financial sophistication of the user, risk tolerance, etc., to better predict the usefulness of a notification.

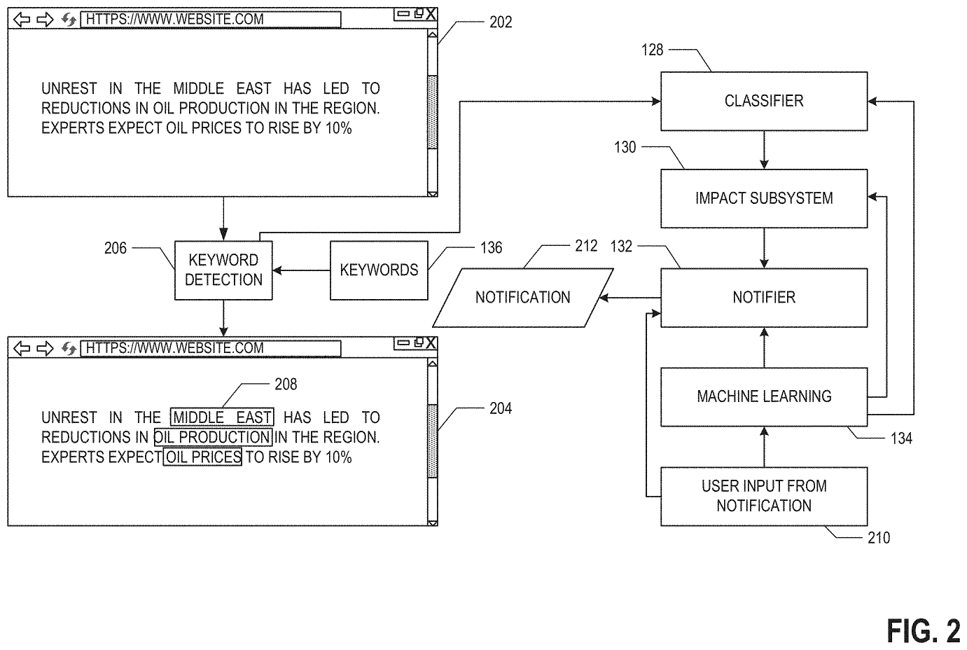

FIG. 2 illustrates a schematic diagram of presenting a notification to a user, according to various examples. FIG. 2 includes web content 202, highlighted web content 204, keyword detection 206, highlighted keyword 208, user input 210, classifier 128, impact subsystem 130, notifier 132, machine learning component 134, and keywords 136. Web content 202 and highlighted web content 204 illustrate the same webpage, but keywords are highlighted in the web page in highlighted web content 204.

Impact subsystem 130 may apply a model developed by machine learning component 134 to determine an impact score. The impact score may indicate a relative chance one or more assets of a user's holdings will change (up or down) based on a currently viewed piece of web content. To calculate the impact score, impact subsystem 130 may utilize classifier 128 to categorize the keywords detected by keyword detection process 206. An impact score may further be based on a sentiment score output by classifier 128.

Keyword detection process 206 may iterate through each renderable word of web content 202 and compare each word to keywords 136. In some example, keyword detection process 206 may also use words from metadata of web content 202. Highlighted web content 204 is a visual representation of the keywords found by keyword detection process 206. In some instances, highlighted web content 204 may be displayed to a user to give them user an indication of why a notification was pushed to the user.

Category scores for one or more categories may be calculated as described previously based on the detected keyword using classifier. One or more sentiment scores may also be determined by classifier 128. For example, an overall sentiment of web content 202 may be determined or a sentiment for each determined category may be determined. A combined category/sentiment score may also be calculated. The combined score may be the function of the category score and sentiment for the category (e.g., [category score]×[sentiment]). Accordingly, a combined score would indicate the potential increase or decrease in assets for a given category.

Impact subsystem 130 may receive the categorization output of classifier 128 (e.g., a vector, file, entries in a database, etc.) and determine the potential impact to one or more users. For example, consider that impact notification service 106 is a plugin and that a user of the web browser displaying web content 202. has logged in using their credentials. Impact notification service 106 may determine (e.g., query a database) the type of user using the credentials. One type of a user may be an end-user and a second type of user may be a financial advisor. Other types of users may be used without departing from the scope of this disclosure. In the instances where the type is an end-user, impact subsystem 130 may determine the impact with respect to that particular user. In contrast, if the type of user is a financial advisor, impact subsystem 130 may determine multiple impact scores—one for each of the clients of the financial advisor using personnel assignments 126.

Impact subsystem 130 may query user holdings 120 to retrieve information on the determined user(s) holdings. The retrieved holdings and output of classifier 128 may be input into machine learning component 134 to determine the potential impact (e.g., an impact score) to the user(s). In an examples, if the impact to the user's holding is above a threshold, notifier 132 may present notification 212 to the user. The threshold may set according to a user preference in some examples. In other instances, a notification model may be used to determine whether or not to notify the user given the impact score. User input 210 with respect to notification 212 may be used as part of machine learning component 134 to further train the notification model.

FIG. 3 illustrates an example of an impact user interface 304. Impact user interface 304 may be presented to an end-user while browsing web content 302. Impact user interface 304 is presented as an in-browser notification with a number of options including details option 306 and fewer notification option 308. A user may select one of the options to interact with the notification. For example, details option 306 may highlight the keywords in web content 302 that triggered the notification. The user may select the “Contact Agent” option to initiate a communication with their agent (e.g., by accessing personnel assignments 126 of FIG. 1).

Impact user interface 304 also presents a human-understandable reasoning of why the notification was presented. The text of impact user interface 304 may be based on the output of a machine learning model from machine learning component 134. In the example in FIG. 3 there is no indication of the class of assets affected, but impact notification service 106 provides more detailed explanations in other examples.

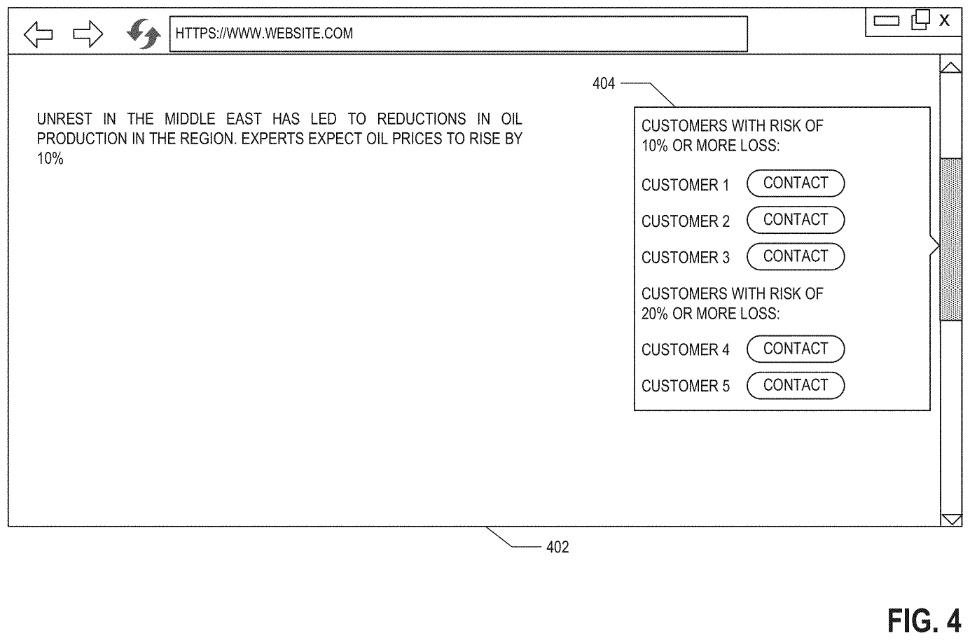

FIG. 4 illustrates an impact user interface 404 according to various examples. Impact user interface 404 may be presented to a financial advisor. In this instance, impact user interface 404 includes a list of customers for the financial advisory that may be adversely affected by web content 402. The financial advisor may set threshold preference(s) related to the potential change in value of their client's portfolios.

FIG. 5 illustrates preferences interface 500, according to various examples. Preferences interface 500 includes a sampling of preferences that may be available to a user with respect to a notification plugin. Preferences interface 500 also includes user name input 502 and password input 504 to identify the user. The preferences may be stored by impact notification service 106 as associated with the inputted username. Threshold setting 506 indicates the level of potential change desired by the user before a notification is sent. In some examples, threshold setting 506 may be omitted in favor of letting a notification model determine when to transmit a notification. Notification preference 510 may be used to set the type of notification. Although not shown, if the “Push” option is selected an additional input box may be displayed to select one or more devices to transmit the notification.

Keyword preferences 508 may identify what keyword sets should be used in analyzing web content. For example, the user may want to add or remove keywords from the keyword sets. Additionally, the user may omit entire keyword sets. In this manner, the user may indicate they do not want any notifications for a certain category regardless of its potential impact on their portfolio.

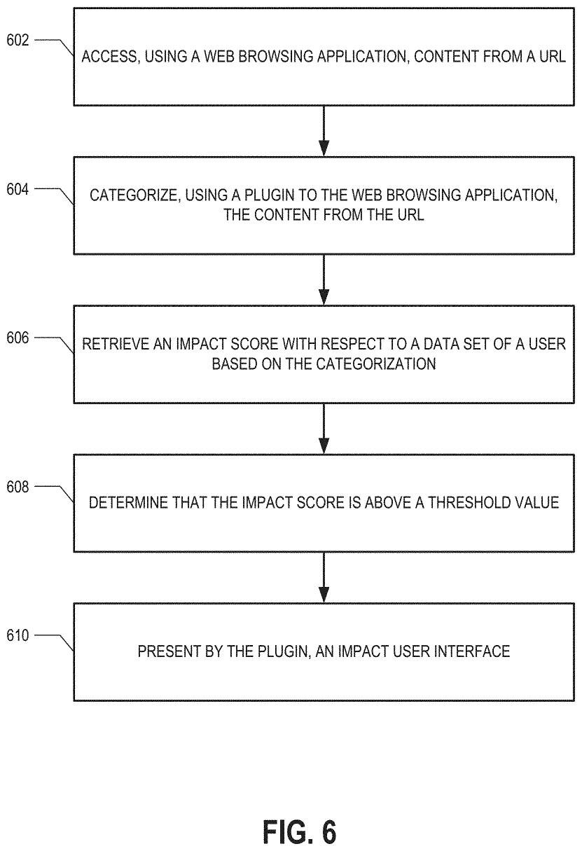

FIG. 6 is a flowchart illustrating a method to an impact user interface, according to various examples. The method may be embodied in a set of instructions stored in at least one non-transitory storage device of a computing device(s). The computing device(s) may have one or more processors that execute the set of instructions to configure the one or more processors to perform the operations illustrated in FIG. 6. To this end, the one or more processors may instruct other parts of the computing device(s) to carry out the set of instructions. For example, the computing device(s) may instruct a network device to transmit data to another computing device(s) or the computing device(s) may provide data over a display interface to present a user interface. In some examples, performance of the method may be split across multiple computing devices.

At operation 602, in an example, content from a universal resource locator (URL) is access using a web browsing application. A user may enter the URL into the web browsing application. Content may be received from a web server located at the URL. The content from the URL may include renderable content and metadata. The renderable content may be viewable to the user while viewing the webpage. Metadata may be included in the source code (e.g., HTML header tags) of the content.

At operation 604, in an example, the content from the URL is categorized using a plugin to the web browsing application. The categorization may done locally at the same computing device that received the content or the plugin may request categorization by an another computing device. Categorizing may include comparing the metadata to a plurality of sets of keywords, wherein a respective set of keywords of the plurality if keywords are associated with at least one respective category. The sets of keywords for the comparison may be determined by the user, by the plugin, or a combination thereof. The results of the categorization may be quantified. For example, a higher score may indicate a higher likelihood the content is related to a respective category. In an example, the categorization includes calculating a sentiment score for the score. A different sentiment score may be calculated for each category or set of keywords.

At operation 606, in an example, an impact score may be retrieved with respect to a data set of a user. The data set may be a set of asset holdings for the user. In some instances impact scores for more than user are received (e.g., a set of clients of a particular user).

The impact score may be based on the categorization and sentiment scores. For example, retrieving may include submitting the categorization score(s), sentiment score(s), and user data set to a machine learning model. The machine learning model may be have been trained on past changes to other data sets based on similar content. Accordingly, the impact score with respect to the data set of the user may be based on historical movement of a component of the data set with respect to similar content as the content from the URL.

At operation 608, in an example, it is determined that the impact score is above a threshold value. And, in response to the determining, at operation 610, an impact user interface is presented. The impact user interface may be a notification to the user presented within the web browser or a push notification sent to a device of the user. The impact user interface may include an indication of a potential impact to the data set of the user based on the impact score. The indication may be a graphical and/or textual description of the impact score (e.g., 5% chance the data set will change 10%). The potential impact may include a change in value of a component of the data set. In some examples, the interface is only presented if the potential change is negative.

In an example, a plurality of respective impact scores are received with respect to a plurality of data sets of a plurality of users based on the categorization. The impact user interface may include presenting indications of a plurality of respective potential impacts to the plurality of data sets based on the plurality of respective impact scores.

In an example, the plugin determines that a likelihood of a user taking an action with respect to the impact user interface is above a threshold before presenting the impact user interface. Actions (e.g., dismiss, initiate electronic communication with an advisor, etc.) may presented in the impact user interface. The likelihood determination may be made by a machine learning model trained using previous responses of the user. If the machine learning model does not have enough data to determine a likelihood, the likelihood may be based on similar users (e.g., similar holdings, demographics, etc.).

The machine learning model may suggest an action based on prior actions taken by the user. The machine learning model may suggest the action based on the magnitude of the potential change and the categorization.

### EXAMPLE COMPUTER SYSTEM

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
accessing, using a web browsing application, content a universal resource locator (URL);
categorizing, using a plugin to the web browsing application, the content from the URL;
retrieving an impact score for the content with respect to a data set of a user based on the categorization;
determining that the impact score is above a threshold value;
determining a suggested action, of a plurality of potential actions, for the user to perform, wherein the suggested action is determined based on the categorization and impact score;
determining, using a notification component of a machine learning model, a notification usefulness score for presenting the user with a notification of the suggested action, wherein determining the notification usefulness score includes:
assigning a usefulness value to each of the plurality of potential actions available to the user;
tracking the usefulness value of a selected actions of the plurality of potential actions selected by the user in each of a plurality of prior notifications; and
comparing the notification of the suggested action with the prior notifications to determine the notification usefulness score of the notification based on the usefulness values of the selected actions of the prior notifications;
presenting by the plugin, responsive to the notification usefulness score of the notification indicating the notification is useful, an impact user interface comprising the notification of the suggested action and an indication of a potential impact to the data set of the user based on the impact score.

2. The method of claim 1, wherein the content from the URL includes renderable content and metadata, and wherein categorizing the content from the URL includes:
comparing the metadata to a plurality of sets of keywords, wherein a respective set of keywords of the plurality of keywords are associated with at least one respective category.

3. The method of claim 2, where categorizing the content from the URL further includes, calculating a sentiment analysis score for the content.

4. The method of claim 3, wherein the impact score is based in part on the sentiment analysis and the comparing.

5. The method of claim 1, wherein the impact score to the data set of the user is based on historical movement of a component of the data set with respect to similar content as the content from the URL.

6. The method of claim 1, wherein the potential impact includes a change in value of a component in the data set.

7. The method of claim 1, further comprising:
receiving a plurality of respective impact scores with respect to a plurality of data sets of a plurality of users based on the categorization; and
wherein presenting the impact user interface includes:
presenting indications of a plurality of respective potential impacts to the plurality of data sets based on the plurality of respective impact scores.

8. The method of claim 1, further comprising:
determining that a likelihood of the user taking an action with respect to the impact user interface is above an action threshold before presenting the impact user interface.

9. The method of claim 8, wherein an action with respect o the impact user interface includes an option to initiate an electronic communication.

10. (canceled)

11. A non-transitory computer readable medium comprising instructions, which when executed by at least one processor, configure the at least one processor to perform operations comprising:
accessing, using a web browsing application, content from a universal resource locator (URL);
categorizing, using a plugin to the web browsing application, the content from the URL;
retrieving an impact score for the content with respect to a data set of a user based on the categorization;
determining that the impact score is above a threshold value;
determining, using a machine learning model, a suggested action of a plurality of potential actions for the user to perform, wherein the machine learning model is trained using a set of prior suggested actions with corresponding assigned usefulness values and prior actions performed by the user for categorizations and impact scores, wherein determining the suggested action with the machine learning model comprises instructions to perform operations comprising:
providing the categorization and impact score as input to the machine learning model to determine a set of suggested actions; and
identifying the suggested action from the set of suggested actions from the machine learning model by prioritizing based on usefulness values for each suggested action of the set of suggested actions;
assigning, using a notification component of the machine learning model, a notification usefulness score for presenting the user with a notification of the suggested action, wherein assigning the notification usefulness score includes:
determining notification usefulness scores for prior notifications of suggested actions based on the usefulness value of a selected action of the plurality of potential actions that was selected by the user; and
comparing the notification of the suggested action with the prior notifications to determine which notification usefulness score that should be assigned to the notification;
evaluating the notification usefulness score of the notification to determine whether the notification should be presented to the user; and
presenting by the plugin, responsive to the notification usefulness score indicating the notification is useful, an impact user interface comprising the notification of the suggested action and an indication of a potential impact to the data set of the user based on the impact score.

12. The non-transitory computer-readable medium of claim 11, wherein the content from the URL includes renderable content and metadata, and wherein categorizing the content from the URL includes:
comparing the metadata to a plurality of sets of keywords, wherein a respective set of keywords of the plurality of keywords are associated with at least one respective category.

13. The non-transitory computer-readable medium of claim 12, where categorizing the content from the URL further includes, calculating a sentiment analysis score for the content.

14. The non-transitory computer-readable medium of claim 13, wherein the impact score is based in part on the sentiment analysis and the comparing.

15. The non-transitory computer-readable medium of claim 11, wherein the impact score to the data set of the user is based on historical movement of a component of the data set with respect to similar content as the content from the URL.

16. The non-transitory computer-readable medium of claim 11, wherein the potential impact includes a change in value of a component in the data set.

17. The non-transitory computer-readable medium of claim 11, the instructions to further configure, when executed by the at least one processor, to perform operations comprising:
receiving a plurality of respective impact scores with respect to a plurality of data sets of a plurality of users based on the categorization; and
wherein presenting the impact user interface includes:
presenting indications of a plurality of respective potential impacts to the plurality of data sets based on the plurality of respective impact scores.

18. The non-transitory computer-readable medium of claim 11, the instructions to further configure, when executed by the at least one processor, to perform operations comprising:
determining that a likelihood of the user taking an action with respect to the impact user interface is above an action threshold before presenting the impact user interface.

19. The non-transitory computer-readable medium of claim 18, wherein an action with respect to the impact user interface includes an option to initiate an electronic communication.

20. A system comprising:
at least one processor; and
memory comprising instructions, which when executed by the at least one processor, cause the at least one processor to:
access, using a web browsing application, content from a universal resource locator (URL);
categorize, using a plugin to the web browsing application, the content from the URL;
retrieve an impact score for the content with respect to a data set of a user based on the categorization;
determine that the impact score is above a threshold value;
determine, using a machine learning model, a suggested action of a plurality of potential actions for the user to perform, wherein the machine learning model is trained using a set of prior suggested actions with corresponding assigned usefulness values and prior actions performed by the user for categorizations and impact scores, wherein determining the suggested action with the machine learning model includes instructions, which when executed by the at least one processor, cause the at least one processor to:
provide the categorization and impact score as input to the machine learning model to determine a set of suggested actions; and
identify the suggested action from the set of suggested actions from the machine learning model by prioritizing based on usefulness values for each suggested action of the set of suggested actions;
determine, using a notification component of the machine learning model, a notification usefulness score for presenting the user with a notification of the suggested action, wherein determining the notification usefulness score includes:
calculating prior notification usefulness scores for prior notifications of suggested actions based on the usefulness value of a selected action of the plurality of potential actions that was selected by the user; and
compare the notification of the suggested action with the prior notifications to determine which prior usefulness score applies to the notification;
determine whether the notification usefulness score indicates that the notification is likely useful; and
present by the plugin, responsive to the notification usefulness score indicating that the notification is likely useful, an impact user interface comprising the notification of the suggested action and an indication of a potential impact to the data set of the user based on the impact score.
